(19) United States
(12) Patent Application Publication
(10) Pub. No.: US 2024/0313456 A1
(43) Pub. Date: Sep. 19, 2024

(54) FEMALE CONNECTOR, MALE CONNECTOR, AND CONNECTOR ASSEMBLY

(71) Applicant: HUAWEI TECHNOLOGIES CO., LTD., Shenzhen (CN)

(72) Inventors: Jun Chen, Dongguan (CN); Tao Ye, Dongguan (CN); Shuang Qiu, Dongguan (CN)

(21) Appl. No.: 18/673,585

(22) Filed: May 24, 2024

Related U.S. Application Data
(63) Continuation of application No. PCT/CN2022/107836, filed on Jul. 26, 2022.

(30) Foreign Application Priority Data
Nov. 26, 2021 (CN) 202111425913.4

(51) Int. Cl. H01R 13/11; H01R 13/6581

(52) U.S. Cl. CPC H01R 13/112; H01R 13/6581

(57) ABSTRACT

Embodiments of this application provide a female connector, a male connector, and a connector assembly. The female connector includes a housing assembly and a female signal terminal. A first end of the housing assembly is provided with a jack that is used to plug into the male connector. The female signal terminal has an accommodation cavity, and one end that is of the female signal terminal and that faces the jack has a port that communicates with the accommodation cavity. When the male connector is connected to the female connector through the jack, a male signal terminal is inserted into the accommodation cavity of the female signal terminal through the port, and the male signal terminal is in an electrical contact connection with the female signal terminal at the port, to implement matching contact between the male signal terminal and the female signal terminal.

### CROSS-REFERENCE TO RELATED APPLICATIONS

This application is a continuation of International Application No. PCT/CN2022/107836, filed on Jul. 26, 2022, which claims priority to Chinese Patent Application No. 202111425913.4, filed on Nov. 26, 2021. The disclosures of the aforementioned applications are hereby incorporated by reference in their entireties.

### TECHNICAL FIELD

This application relates to the field of communication technologies, and in particular, to a female connector, a male connector, and a connector assembly.

### BACKGROUND

With wide application and continuous improvement of communication technologies, requirements for a data transmission rate and transmission quality are increasingly high. A high-speed connector is widely used in the communication field. The high-speed connector gradually becomes a common connector for a large communication device, an ultra-high-performance server, a supercomputer, an industrial computer, a high-end storage device, and the like.

Currently, a high-speed electrical connector assembly used for high-speed signal transmission generally includes a pair of female connector and male connector that can be plugged into each other. There may be a plurality of jacks that are arranged in an array on the female connector. There is a plastic first support member in the jack. A female signal terminal is disposed in an accommodation slot of the first support member. There are a plurality of plastic second support members on the male connector. A male signal terminal is disposed in an accommodation slot of the second support member. The second support member of the male connector can be plugged into the female connector through the jack. The female signal terminal is in an electrical contact connection with the male signal terminal. The female signal terminal and the male signal terminal are usually elastic sheets with protruding parts. The female signal terminal and the male signal terminal are in contact and connected to each other through the protruding parts.

However, bandwidth of the foregoing connector assembly still needs to be further increased, to meet an increasing requirement for a high-speed signal transmission rate.

### SUMMARY

Embodiments of this application provide a female connector, a male connector, and a connector assembly, to resolve a problem that bandwidth of an existing connector assembly still needs to be further increased.

An aspect of embodiments of this application provides a female connector, configured to be connected to a male connector, and including a housing assembly and a female signal terminal located in the housing assembly. A first end of the housing assembly is provided with a jack that is used to plug into the male connector.

The female signal terminal has an accommodation cavity. One end that is of the female signal terminal and that faces the jack has a port. The port communicates with the accommodation cavity. The female signal terminal is configured to enable a male signal terminal of the male connector to be inserted into the accommodation cavity through the port. The female signal terminal is in an electrical contact connection with the male signal terminal at the port. To be specific, when the male connector is plugged into the female connector through the jack, the male signal terminal is inserted into the accommodation cavity of the female signal terminal through the port, and the female signal terminal is in the electrical contact connection with the male signal terminal at the port, to implement matching between the male signal terminal and the female signal terminal, and implement an electrical connection between the female connector and the male connector.

A medium in the accommodation cavity is air, that is, a medium at a contact position between the male signal terminal and the female signal terminal and a medium in an overlapping area between the female signal terminal and the male signal terminal are both air, no plastic member is introduced, and a dielectric constant dk value of air is low (a relative dielectric constant dk value is equal to 1). This effectively increases insertion loss bandwidth of the female connector, increases bandwidth of the connector assembly, and increases a signal transmission rate.

In addition, one end of the male signal terminal is inserted into the accommodation cavity of the female signal terminal. In other words, the female signal terminal wraps one end of the male signal terminal inside. A cavity wall of the accommodation cavity is a metal piece, that is, a metal cavity is formed. The contact position and the overlapping area between the female signal terminal and the male signal terminal are both located in the metal cavity. Because an electromagnetic field propagates on an outer surface of metal, a stub effect in the metal cavity can be effectively reduced. This helps further increase bandwidth of the connector.

In a possible implementation, the female signal terminal includes a first arc-shaped part and a second arc-shaped part. The first arc-shaped part and the second arc-shaped part are disposed opposite to each other to form the accommodation cavity. A first end of the first arc-shaped part and a first end of the second arc-shaped part form the port. In this way, the first arc-shaped part and the second arc-shaped part are disposed opposite to each other, to form a cylindrical structure in which the accommodation cavity is provided. The structure is simple and easy to implement.

In a possible implementation, there is a gap between the first arc-shaped part and the second arc-shaped part.

The female signal terminal further includes a first extension part and a second extension part that are disposed opposite to each other. A first end of the first extension part is connected to a second end of the first arc-shaped part. A second end of the first extension part extends towards the second extension part.

A first end of the second extension part is connected to a second end of the second arc-shaped part. A second end of the second extension part extends towards the first extension part. The second end of the second extension part is connected to the second end of the first extension part. The first extension part and the second extension part form a splayed structure, and the first arc-shaped part and the second arc-shaped part are connected through the first extension part and the second extension part. The male signal terminal is in an electrical contact connection with the female signal terminal at the port. Signals are transmitted separately through the first arc-shaped part and the second arc-shaped part, are converged when transmitted to the second end of the first arc-shaped part and the second end of the second arc-shaped part, and continue to be transmitted to a female cable connected to the female signal terminal. This ensures that the signals can be simultaneously transmitted from the male signal terminal to the female cable during transmission. Compared with that the signals are transmitted to the female cable only through the first arc-shaped part or the second arc-shaped part, this can prevent an antenna effect occurring on the second end of the first arc-shaped part and the second end of the second arc-shaped part from causing interference to the transmitted signals, and increases the bandwidth of the connector.

In a possible implementation, the female connector further includes the female cable. One end of the female cable is located in the housing assembly. The other end of the female cable extends out of the housing assembly.

The female signal terminal further includes a first connection part and a second connection part. The first connection part is located on the second end of the first extension part. The first connection part is electrically connected to one end of the female cable.

The second connection part is located on the second end of the second extension part. The second connection part is electrically connected to the first connection part. Therefore, the first extension part and the second extension part are connected through the first connection part and the second connection part. This can facilitate a connection between the first extension part and the second extension part. The first connection part and the second connection part may be in a shape of a flat plate. This can further facilitate the connection between the first connection part and the second connection part.

In a possible implementation, the female connector further includes a plug connector. The plug connector is located between the jack and the female signal terminal. A through hole is provided on the plug connector. The through hole is provided opposite to the jack. The plug connector can guide the male signal terminal to be smoothly inserted into the accommodation cavity of the female signal terminal. In addition, the plug connector can further protect the female signal terminal, and avoid abrasion of the female signal terminal caused by an insertion position deviation.

In a possible implementation, the female signal terminal further includes a first guide part and a second guide part. The first guide part is located on the first end of the first arc-shaped part. The second guide part is located on the first end of the second arc-shaped part.

A first end of the first guide part is connected to the first arc-shaped part. A second end of the first guide part extends away from the second guide part. The second end of the first guide part is located on the plug connector.

A first end of the second guide part is connected to the second arc-shaped part, a second end of the second guide part extends away from the first guide part, the second end of the second guide part is located on the plug connector, and the second end of the first guide part and the second end of the second guide part are respectively located on two opposite sides of an outer periphery of the through hole. The first guide part and the second guide part form a structure with a splayed cross section, that is, the structure with the splayed cross section is formed on a side that is of the port and that faces the jack. The first guide part and the second guide part are disposed on the plug connector. In this way, the through hole communicates with the port through the splayed structure formed by the first guide part and the second guide part. The first guide part and the second guide part can implement a guiding and limiting function, to further ensure that the male signal terminal is smoothly inserted into the female signal terminal. This reduces or avoids damage to the male signal terminal or the female signal terminal caused by a plug deviation.

In a possible implementation, each jack corresponds to a pair of female signal terminals. Gaps of the pair of female signal terminals are provided opposite to each other. The first arc-shaped part and the second arc-shaped part are located on upper and lower sides of the gap. The first guide part is located on the first arc-shaped part. The second guide part is located on the second arc-shaped part. In this case, the first guide part and the second guide part are located on the upper and lower sides of the gap. To be specific, two ends of the structure with the splayed cross section formed by the first guide part and the second guide part are located in a vertical direction, so that a size of the female signal terminal in a horizontal direction can be reduced. In this way, when a width of the female connector in a horizontal direction is fixed, more female signal terminals can be placed. This helps implement a high-density design of the female connector, and further improves signal transmission performance of the female connector.

In a possible implementation, there are a first positioning slot and a second positioning slot on a side that is of the plug connector and that faces the female signal terminal. The first positioning slot and the second positioning slot are respectively located on two opposite sides of the outer periphery of the through hole.

The female signal terminal further includes a first pressing part and a second pressing part. The first pressing part is located on the second end of the first guide part. The second pressing part is located on the second end of the second guide part.

The first guide part is disposed on the plug connector through cooperation between the first pressing part and the first positioning slot. The second guide part is disposed on the plug connector through cooperation between the second pressing part and the second positioning slot. In this way, the female signal terminal is fixedly connected to the plug connector. The first positioning slot and the second positioning slot can implement a limiting function, to stably dispose the female signal terminal in the housing assembly. This reduces or avoids displacement of the female signal terminal. In addition, the plug connector can press against and limit the female signal terminal, to prevent the female signal terminal from sliding out of the jack. This further improves stability of the female signal terminal.

In a possible implementation, the female signal terminal further includes a ring-shaped part. The second end of the first arc-shaped part and the second end of the second arc-shaped part are separately connected to the ring-shaped part. The first end of the first extension part and the first end of the second extension part are separately connected to the ring-shaped part. The accommodation cavity communicates with an inner cavity of the ring-shaped part. The ring-shaped part implements a connection between the first arc-shaped part and the second arc-shaped part and a connection between the first extension part and the second extension part. This can facilitate forming of the female signal terminal, enhance strength of the female signal terminal, and improve matching connection reliability between the female signal terminal and the male signal terminal.

In a possible implementation, the housing assembly includes a shielding housing. The shielding housing includes a bottom shielding sheet, a top shielding sheet, and a plurality of side shielding sheets. The plurality of side shielding sheets are disposed in parallel on the bottom shielding sheet. The top shielding sheet covers the plurality of side shielding sheets.

The bottom shielding sheet, the side shielding sheets, and the bottom shielding sheet form a plurality of shielding cavities with openings at two ends. An opening at one end of the shielding cavity forms the jack. A pair of female signal terminals is disposed in each shielding cavity, and two adjacent shielding cavities are isolated through the side shielding sheet. To be specific, the side shielding sheet isolates the two adjacent shielding cavities, so that the two shielding cavities do not communicate with each other and are isolated. In this way, each pair of female signal terminals is located in a shielding cavity that is fully enclosed around 360°, that is, a differential pair formed by the female signal terminals is fully coated and enclosed. This significantly enhances shielding effect, reduces or avoids crosstalk between adjacent signal differential pairs, and further increases the bandwidth of the connector.

In a possible implementation, there are a plurality of shielding housings. The plurality of shielding housings are stacked. This can implement a high-density design of the female signal terminal, and further improve the signal transmission performance of the connector.

In a possible implementation, the housing assembly further includes a female housing. The female housing is sleeved on one end of each of the plurality of shielding housings. The female housing may fasten a plurality of layers of shielding housings. In addition, the female housing may be fastened to a male housing of the male connector, to implement a connection between the female connector and the male connector.

In a possible implementation, there is a protruding first limiting part on an outer wall of two ends of the shielding housing. An inner wall of the female housing is provided with a first limiting slot cooperating with the first limiting part. The shielding housing is connected to the female housing through cooperation between the first limiting part and the first limiting slot. The first limiting part is inserted into the first limiting slot. In this way, the shielding housing is fastened in the female housing, and a structure is simple and facilitates disassembly and maintenance.

In a possible implementation, there is a limiting boss on the side shielding sheet. The top shielding sheet is provided with a limiting clamping slot cooperating with the limiting boss. The top shielding sheet is connected to the side shielding sheet through cooperation between the limiting boss and the limiting clamping slot. For example, the limiting boss may extend into the limiting clamping slot, and form an interference fit with the limiting clamping slot. In this way, the top shielding sheet is fastened to the side shielding sheet. This facilitates implementation and facilitates assembly and disassembly.

A second aspect of this application provides a female connector, configured to be connected to a male connector, and including a shielding housing and a female signal terminal. The shielding housing includes a bottom shielding sheet, a top shielding sheet, and a plurality of side shielding sheets. The plurality of side shielding sheets are disposed in parallel on the bottom shielding sheet. The top shielding sheet covers the plurality of side shielding sheets.

The bottom shielding sheet, the side shielding sheets, and the bottom shielding sheet form a plurality of shielding cavities with openings at two ends. An opening at one end of the shielding cavity forms a jack that is used to plug into the male connector. A pair of female signal terminals is disposed in each shielding cavity. The female signal terminal is configured to be in an electrical contact connection with a male signal terminal of the male connector, and two adjacent shielding cavities are isolated through the side shielding sheet. To be specific, the side shielding sheet isolates the two adjacent shielding cavities, so that the two shielding cavities do not communicate with each other and are isolated. In this way, each pair of female signal terminals is located in a shielding cavity that is fully enclosed around 360°, that is, a differential pair formed by the female signal terminals is fully coated and enclosed. This significantly enhances shielding effect, reduces or avoids crosstalk between adjacent signal differential pairs, increases bandwidth of the connector, further increases bandwidth of a connector assembly, and increases a signal transmission rate.

A third aspect of this application provides a female signal terminal, configured to be connected to a male signal terminal, and including a first arc-shaped part and a second arc-shaped part. The first arc-shaped part and the second arc-shaped part are disposed opposite to each other to form an accommodation cavity. A first end of the first arc-shaped part and a first end of the second arc-shaped part form a port that is used to plug into the male signal terminal. There is a gap between the first arc-shaped part and the second arc-shaped part.

The female signal terminal further includes a first extension part and a second extension part that are disposed opposite to each other. A first end of the first extension part is connected to a second end of the first arc-shaped part. A second end of the first extension part extends towards the second extension part.

A first end of the second extension part is connected to a second end of the second arc-shaped part. A second end of the second extension part extends towards the first extension part. The second end of the second extension part is connected to the second end of the first extension part. In this way, the first arc-shaped part and the second arc-shaped part are connected through the first extension part and the second extension part. The male signal terminal is in an electrical contact connection with the female signal terminal at the port. Signals are transmitted separately through the first arc-shaped part and the second arc-shaped part, are converged when transmitted to the second end of the first arc-shaped part and the second end of the second arc-shaped part, and continue to be transmitted to a female cable connected to the female signal terminal. This ensures that the signals can be simultaneously transmitted from the male signal terminal to the female cable during transmission. Compared with that the signals are transmitted to the female cable only through the first arc-shaped part or the second arc-shaped part, this can prevent an antenna effect occurring on the second end of the first arc-shaped part and the second end of the second arc-shaped part (for example, if the first arc-shaped part is connected to the female cable, an antenna effect occurs on the second end of the second arc-shaped part) from causing interference to the transmitted signals, increases bandwidth of a connector, further increases bandwidth of a connector assembly, and increases a signal transmission rate.

A fourth aspect of this application provides a male connector, configured to be connected to any one of the foregoing female connectors, and including a support assembly and a male signal terminal.

The support assembly includes a terminal support member and a shielding member. The shielding member is disposed around an outer periphery of the terminal support member. One end of the male signal terminal is located in the terminal support member. The other end of the male signal terminal extends out of one end of the support assembly.

The end of the support assembly is configured to be inserted into a jack, so that the male signal terminal is inserted into an accommodation cavity of a female signal terminal. A medium in the accommodation cavity is air, that is, a medium at a contact position between the male signal terminal and the female signal terminal and a medium in an overlapping area between the female signal terminal and the male signal terminal are both air, no plastic member is introduced, and a dielectric constant value of air is low. This effectively increases bandwidth of a connector assembly, increases bandwidth of the connector assembly, and increases a signal transmission rate.

In addition, the shielding member of the male connector is disposed around the outer periphery of the terminal support member. To be specific, the shielding member is coated on a side surface of the outer periphery of the terminal support member. In this way, the male signal terminal can be fully coated and shielded. This improves shielding effect, increases bandwidth of the connector, further increases the bandwidth of the connector assembly, and increases the signal transmission rate.

In a possible implementation, there is a protruding part on the shielding member. The protruding part is configured to cooperate with an inner wall of the jack, so that the support assembly is disposed in the jack. In this way, the male connector is fastened in the jack. This further improves connection stability between the male connector and the female connector.

In a possible implementation, the male connector further includes a male housing. A plurality of support assemblies are arranged in an array in the male housing.

A fifth aspect of this application provides a connector assembly, including any one of the foregoing female connectors and any one of the foregoing male connectors.

The male connector is plugged into the female connector through a jack. A male signal terminal is inserted into an accommodation cavity through a port. The male signal terminal is in an electrical contact connection with a female signal terminal.

In a possible implementation, one end of a female housing of the female connector is plugged into a male housing of the male connector.

There is a protruding second limiting part on an outer wall of one end of the female housing. An inner wall of the male housing is provided with a second limiting slot cooperating with the second limiting part. The female housing is connected to the male housing through cooperation between the second limiting part and the second limiting slot. The second limiting part may be inserted into the second limiting slot, so that the female housing and the male housing are plugged into each other. This improves connection stability between the female connector and the male connector, and facilitates plug assembly, disassembly, and the like.

### BRIEF DESCRIPTION OF DRAWINGS

FIG. 1 is a schematic sectional view of a matching connection between an existing male connector and an existing female connector;

FIG. 2 is a schematic diagram of a structure of a connector assembly according to an embodiment of this application;

FIG. 3 is a schematic diagram of disassembly of a connector assembly according to an embodiment of this application;

FIG. 4 is a schematic diagram of a structure of a female connector according to an embodiment of this application;

FIG. 5 is a front view of a female connector according to an embodiment of this application;

FIG. 6 is a front view of female signal terminals at one layer of a female connector according to an embodiment of this application;

FIG. 7 is a schematic sectional view of female signal terminals at one layer of a female connector according to an embodiment of this application;

FIG. 8 is a schematic diagram of a structure of matching between a female signal terminal and a male signal terminal according to an embodiment of this application;

FIG. 9 is a schematic diagram of a cross-sectional structure of matching between a female signal terminal and a male signal terminal according to an embodiment of this application;

FIG. 10 is a schematic diagram of a structure of a female signal terminal according to an embodiment of this application;

FIG. 11 is a side view of a female signal terminal according to an embodiment of this application;

FIG. 12 is a schematic diagram of a cross-sectional structure of a female signal terminal according to an embodiment of this application;

FIG. 13 is another schematic diagram of a cross-sectional structure of a female signal terminal according to an embodiment of this application;

FIG. 14 is still another schematic diagram of a cross-sectional structure of a female signal terminal according to an embodiment of this application;

FIG. 15 is a front view of a female signal terminal according to an embodiment of this application;

FIG. 16 is a schematic diagram of a partial disassembled structure of a plug connector in a female connector according to an embodiment of this application;

FIG. 17 is a front view of partial disassembly of a plug connector in a female connector according to an embodiment of this application;

FIG. 18 is a front view of a cross section of a female connector according to an embodiment of this application;

FIG. 19 is a partially enlarged schematic diagram of a cross-sectional structure of a female connector at a plug connector according to an embodiment of this application;

FIG. 20 is a schematic diagram of distribution of female signal terminals in a female connector according to an embodiment of this application;

FIG. 21 is a schematic diagram of disassembly of a female connector according to an embodiment of this application;

FIG. 22 is a schematic diagram of stacked shielding housings according to an embodiment of this application;

FIG. 23 is a schematic diagram of a structure of a female housing according to an embodiment of this application;

FIG. 24 is a schematic diagram of an assembly structure of a shielding housing and a female signal terminal according to an embodiment of this application;

FIG. 25 is a schematic diagram of a disassembly structure of a shielding housing and a female signal terminal according to an embodiment of this application;

FIG. 26 is a schematic diagram of an assembly structure of a bottom shielding sheet and a side shielding sheet according to an embodiment of this application;

FIG. 27 is an enlarged view of a partial structure of assembly between a shielding housing and a female signal terminal according to an embodiment of this application;

FIG. 28 is an enlarged view of a partial structure of assembly of a shielding housing according to an embodiment of this application;

FIG. 29 is a schematic diagram of a structure of a male connector according to an embodiment of this application;

FIG. 30 is a schematic diagram of a structure of a male housing according to an embodiment of this application;

FIG. 31 is a schematic diagram of a cross-sectional structure of one layer of a male connector according to an embodiment of this application;

FIG. 32 is a schematic diagram of a front structure of one layer of a male connector according to an embodiment of this application;

FIG. 33 is a schematic diagram of a back structure of one layer of a male connector according to an embodiment of this application;

FIG. 34 is a schematic diagram of a cross-sectional structure of matching between a male connector and a female connector according to an embodiment of this application; and

FIG. 35 is a schematic diagram of a simulation result of an insertion loss and crosstalk of a connector assembly according to an embodiment of this application.

### DESCRIPTIONS OF REFERENCE NUMERALS

100: connector assembly; 10: female connector; 11: housing assembly;
111: female housing; 1111: first limiting slot; 1112: second limiting part;
112: shielding housing; 1121: bottom shielding sheet; 1122: side shielding sheet;
1122a: limiting boss; 1123: top shielding sheet; 1123a: limiting clamping slot;
1124: first limiting part; 112a: shielding cavity; 12: female signal terminal;
121: accommodation cavity; 122: port; 123a: first arc-shaped part;
123b: second arc-shaped part; 123: gap; 124a: first extension part;
124b: second extension part; 125a: first connection part; 125b: second connection part;
126: ring-shaped part; 127a: first guide part; 127b: second guide part;
128a: first pressing part; 128b: second pressing part; 13: jack;
14: plug connector; 141: through hole; 142: first positioning slot;
143: second positioning slot; 20: male connector; 21: support assembly;
211: terminal support member; 212: shielding member; 2121: protruding part;
22: male signal terminal; 23: male housing; 231: second limiting slot.

### DESCRIPTION OF EMBODIMENTS

Terms used in implementations of this application are only used to explain specific embodiments of this application, but are not intended to limit this application.

A connector means an electrical connector, and is a device that connects two electrical devices to transmit a current or a signal. With continuous development of communication technologies, a high-speed connector becomes one of common electronic devices in the communication field. For example, a backplane and a board are disposed in a communication device. A high-speed signal interconnection exists between boards or between the board and the backplane, to implement a communication function. A connection between the board and the backplane is used as an example. To implement a signal connection, the board and the backplane may be connected to each other through a connector assembly.

FIG. 1 is a schematic sectional view of a matching connection between an existing male connector and an existing female connector.

A connector assembly usually includes a male connector and a female connector. The male connector and the female connector are plugged into each other. For example, one end of the male connector may be connected to a backplane. One end of the female connector may be connected to a board. The other end of the male connector is plugged into the other end of the female connector. In this way, the backplane and the board can be interconnected.

Specifically, the female connector may have a plurality of accommodation cavities distributed in an array. One end of the female connector may further have a plurality of jacks. Each jack correspondingly communicates with one accommodation cavity. Refer to FIG. 1. A plastic first support member 110 may be disposed in each accommodation cavity. The first support member 110 may be located on a side that is adjacent to a bottom wall of the accommodation cavity. A pair of female signal terminals 120 is further disposed in each accommodation cavity, to form a signal differential pair. The female signal terminal 120 is disposed on the first support member 110. Specifically, a first accommodation slot (not shown in the figure) is provided on the first support member 110. One end of the female signal terminal 120 is located in the first accommodation slot. The female signal terminal 120 is usually a metal elastic sheet. There is a protruding part 120a on one end of the female signal terminal 120. In addition, to reduce crosstalk between adjacent signal differential pairs, a shielding sheet (not shown in the figure) is further disposed on a side wall of the accommodation cavity, to improve shielding effect between two adjacent differential pairs.

The male connector has a plurality of plastic second support members 210. A pair of male signal terminals 220 is disposed on each second support member 210. Specifically, a second accommodation slot that is through (not shown in the figure) is disposed on the second support member 210. The male signal terminal 220 is disposed in the second accommodation slot. The male signal terminal 220 may also be a metal elastic sheet. There is also a protruding part 220a on the male signal terminal 220. When the female connector and the male connector are plugged into each other, the second support member 210 may be inserted into the accommodation cavity through the jack, the protruding part 120a on the female signal terminal 120 is electrically in contact with the male signal terminal 220, and the protruding part 220a on the male signal terminal 220 is electrically in contact with the female signal terminal 120, to implement an electrical connection between the female connector and the male connector. In addition, the female signal terminal 120 and the male signal terminal 220 have a partially overlapping area, to ensure the connection between the female signal terminal 120 and the male signal terminal 220.

The female signal terminal 120 is in contact with the male signal terminal 220, and the overlapping area is surrounded by the plastic first support member 110 and the second support member 210. To be specific, a medium at a contact position between the female signal terminal 120 and the male signal terminal 220, and a medium in the overlapping area of the female signal terminal 120 and the male signal terminal 220 are plastic. A dielectric constant dk value of the plastic is high (a relative dielectric constant dk value is far greater than 1). This causes resonance of an insertion loss to arrive earlier, reduces insertion loss bandwidth, and affects bandwidth of the connector assembly.

To reduce crosstalk between the two adjacent differential pairs, the shielding sheet is disposed on the side wall of the accommodation cavity of the female connector. However, the shielding sheet is usually disposed only on one side or two sides of the accommodation cavity. In addition, there are a large quantity of components and parts on the female connector. Therefore, for ease of disposing, there are some gaps between shielding sheets, and the signal differential pair cannot be fully shielded around 360°. This reduces shielding effect of the connector, and affects the bandwidth of the connector assembly.

In addition, transmission performance of the elastic-sheet-shaped female signal terminal needs to be further improved, to meet a bandwidth requirement of the connector assembly.

Based on this, embodiments of this application provide a female connector, a male connector, and a connector assembly, to effectively increase bandwidth of the connector assembly and increase a signal transmission rate.

With reference to the accompanying drawings, the following describes in detail a female connector, a male connector, and a connector assembly that are provided by embodiments of this application.

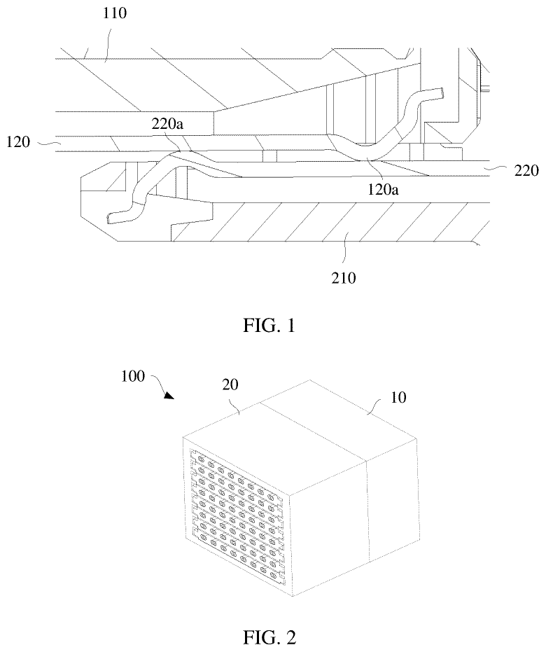

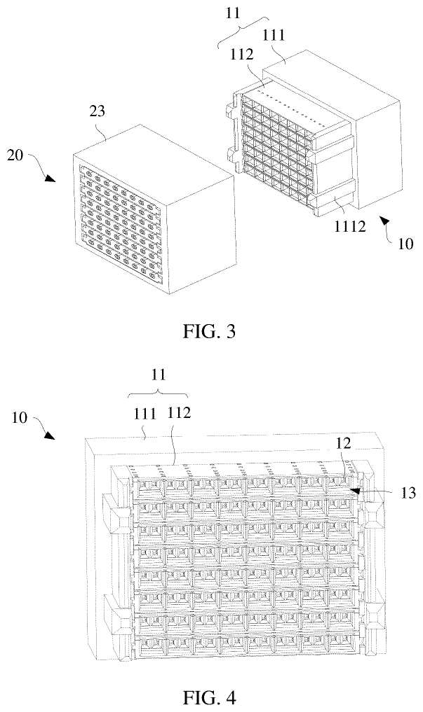

FIG. 2 is a schematic diagram of a structure of a connector assembly according to an embodiment of this application. FIG. 3 is a schematic diagram of disassembly of a connector assembly according to an embodiment of this application.

Refer to FIG. 2. A connector assembly 100 provided by this embodiment of this application includes a female connector 10 and a male connector 20. The male connector 20 and the female connector 10 are plugged into each other. In this case, the male connector 20 and the female connector 10 can be electrically connected.

Specifically, with reference to FIG. 3, the female connector 10 may include a housing assembly 11 and a female signal terminal (not shown in the figure). The female signal terminal may be disposed in the housing assembly 11. The male connector 20 may include a male housing 23 and a male signal terminal (not shown in the figure). The male housing 23 may have a cavity. The male signal terminal may be disposed in the cavity.

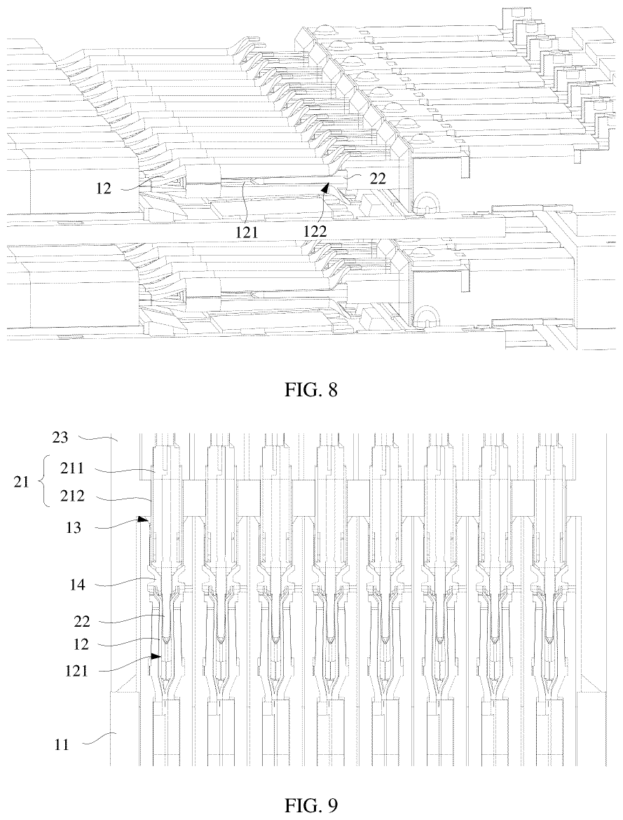

One end of the housing assembly 11 may be inserted into one end of the cavity of the male housing 23 (as shown in FIG. 9), and the female signal terminal is in an electrical contact connection with the male signal terminal. This implements an electrical connection between the female connector 10 and the male connector 20, and implements an interconnection between two electrical devices.

Specifically, the housing assembly 11 may include a female housing 111 and a shielding housing 112. The female signal terminal may be disposed in the shielding housing 112. The female housing 111 is sleeved on the shielding housing 112.

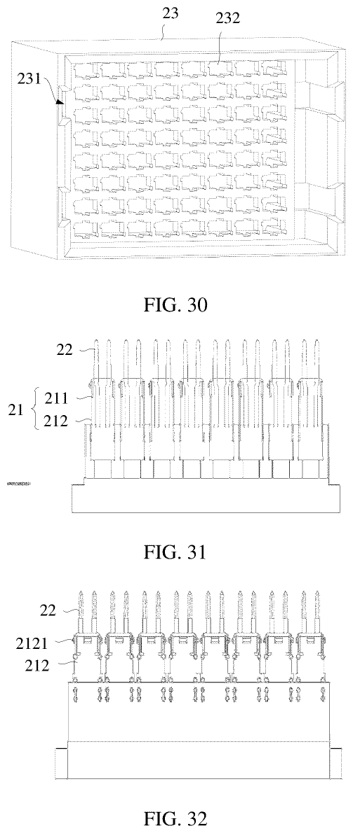

There may be a protruding second limiting part 1112 on an outer wall of one end of the female housing 111. There is a second limiting slot 231 (as shown in FIG. 30) on an inner wall of the cavity at one end of the male housing 23. The second limiting part 1112 cooperates with the second limiting slot 231. For example, the second limiting part 1112 may be inserted into the second limiting slot 231. In this case, the female housing 111 may be connected to the male housing 23 through cooperation between the second limiting part 1112 and the second limiting slot 231.

The female connector 10 may further include a female cable (not shown in the figure). One end of the female cable is located in the housing assembly 11, and is connected to the female signal terminal. The other end of the female cable extends out of the other end of the housing assembly 11, and is configured to be connected to another electrical device.

The male connector 20 may further include a male cable (not shown in the figure). The male signal terminal is located in the male housing 23. One end of the male cable is located in the male housing 23, and is connected to the male signal terminal. The other end of the male cable extends out of the other end of the male housing 23, and is configured to be connected to another electrical device.

With reference to the accompanying drawings, the following describes in detail a female connector and a male connector that are provided by embodiments of this application.

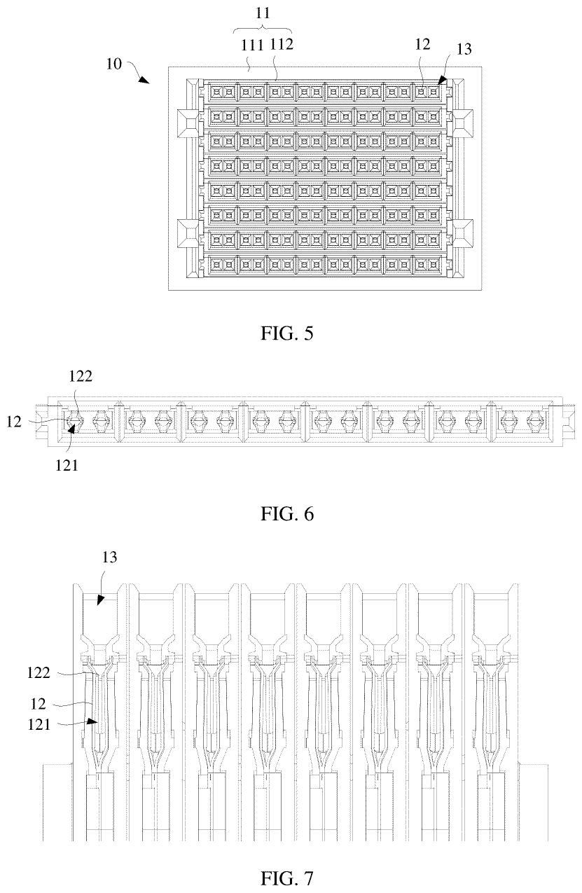

FIG. 4 is a schematic diagram of a structure of a female connector according to an embodiment of this application. FIG. 5 is a front view of a female connector according to an embodiment of this application. FIG. 6 is a front view of female signal terminals at one layer of a female connector according to an embodiment of this application. FIG. 7 is a schematic sectional view of female signal terminals at one layer of a female connector according to an embodiment of this application. FIG. 8 is a schematic diagram of a structure of matching between a female signal terminal and a male signal terminal according to an embodiment of this application. FIG. 9 is a schematic diagram of a cross-sectional structure of matching between a female signal terminal and a male signal terminal according to an embodiment of this application.

Refer to FIG. 4 and FIG. 5. According to a female connector 10 provided by this embodiment of this application, there is a jack 13 on a first end of a housing assembly 11. Specifically, there may be a plurality of jacks 13 that are arranged in an array on the first end of the housing assembly 11. There is a female signal terminal 12 corresponding to the jack 13 in the housing assembly 11. A male connector 20 may be plugged into the female connector 10 through the jack 13, and the male signal terminal 22 is in an electrical contact connection with the female signal terminal 12 located in the housing assembly 11.

Refer to FIG. 6 and FIG. 7. The female signal terminal 12 has an accommodation cavity 121. One end that is of the female signal terminal 12 and that faces the jack 13 has a port 122 that communicates with the accommodation cavity 121. For example, the female signal terminal 12 may be a cylinder having the accommodation cavity 121 inside. At least one end of the cylinder is opened to form the port 122.

Refer to FIG. 8 and FIG. 9. When the male connector 20 is plugged into the female connector 10 through the jack 13, one end of the male signal terminal 22 may be inserted into the accommodation cavity 121 through the port 122 on the female signal terminal 12, and the female signal terminal 12 is in an electrical contact connection with the male signal terminal 22 at the port 122. This implements matching between the male signal terminal 22 and the female signal terminal 12, and implements an electrical connection between the female connector 10 and the male connector 20. To be specific, when the male signal terminal 22 and the female signal terminal 12 are in matching contact, one end of the male signal terminal 22 is plugged into the accommodation cavity 121 of the female signal terminal 12. A medium in the accommodation cavity 121 is air, that is, a medium at a contact position between the male signal terminal 22 and the female signal terminal 12 and a medium in an overlapping area between the female signal terminal 12 and the male signal terminal 22 are both air, no plastic member is introduced, and a dielectric constant dk value of air is low (a relative dielectric constant dk value is equal to 1). This effectively increases insertion loss bandwidth of the female connector 10, increases bandwidth of a connector assembly 100, and increases a signal transmission rate.

In addition, one end of the male signal terminal 22 is inserted into the accommodation cavity 121 of the female signal terminal 12. A cavity wall of the accommodation cavity 121 is a metal piece, that is, a metal cavity is formed, and the female signal terminal 12 wraps one end of the male signal terminal 22 inside the metal cavity. The contact position and the overlapping area between the female signal terminal 12 and the male signal terminal 22 are both located in the metal cavity. Because an electromagnetic field propagates on an outer surface of metal, an antenna effect (a stub effect) in the metal cavity can be effectively reduced. This helps further increase bandwidth of the connector.

An inner diameter of the port 122 of the female signal terminal 12 may be slightly less than a minimum inner diameter of the accommodation cavity 121, so that the port 122 may clamp the male signal terminal 22. This ensures that the male signal terminal 22 and the female signal terminal 12 are in good contact at a position of the port 122, to ensure connection reliability.

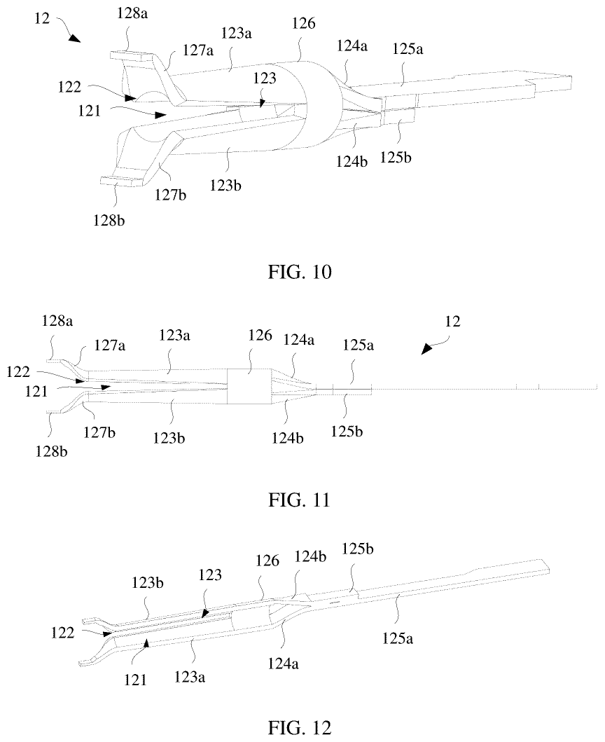

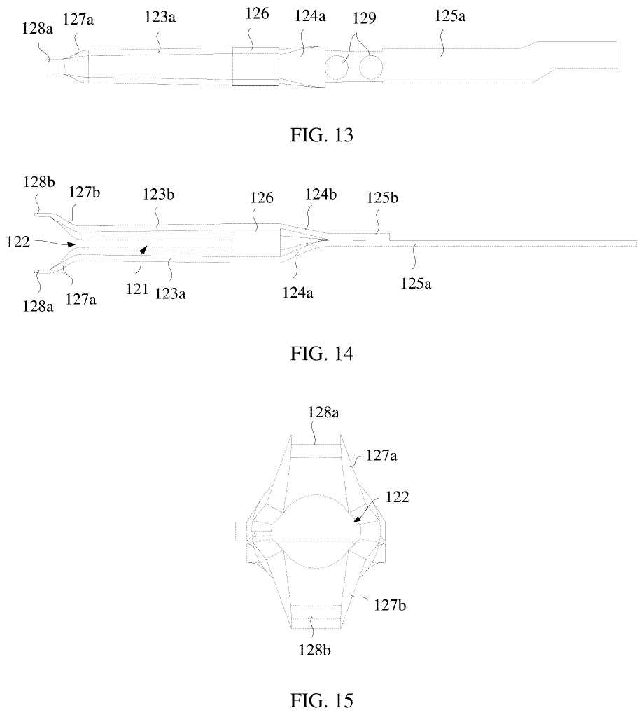

FIG. 10 is a schematic diagram of a structure of a female signal terminal according to an embodiment of this application. FIG. 11 is a side view of a female signal terminal according to an embodiment of this application. FIG. 12 is a schematic diagram of a cross-sectional structure of a female signal terminal according to an embodiment of this application. FIG. 13 is another schematic diagram of a cross-sectional structure of a female signal terminal according to an embodiment of this application. FIG. 14 is still another schematic diagram of a cross-sectional structure of a female signal terminal according to an embodiment of this application. FIG. 15 is a front view of a female signal terminal according to an embodiment of this application.

Specifically, refer to FIG. 10 and FIG. 11. A female signal terminal 12 includes a first arc-shaped part 123a and a second arc-shaped part 123b. The first arc-shaped part 123a and the second arc-shaped part 123b are disposed opposite to each other to form an accommodation cavity 121. The first arc-shaped part 123a and the second arc-shaped part 123b may have a same shape, and the first arc-shaped part 123a and the second arc-shaped part 123b are symmetrically disposed. In this case, the cylinder-like female signal terminal 12 is formed, and is provided with an accommodation cavity 121 inside. A first end of the first arc-shaped part 123a and a first end of the second arc-shaped part 123b form a port 122. A male signal terminal 22 extends into the accommodation cavity 121 through the port 122.

The female signal terminal 12 may be formed in a plurality of manners. The first arc-shaped part 123a and the second arc-shaped part 123b may be separately formed and then disposed opposite to each other, to form the female signal terminal 12 having the accommodation cavity 121 inside. Alternatively, the first arc-shaped part 123a and the second arc-shaped part 123b may be formed together to form the female signal terminal 12. For example, a strip-shaped laminate like a metal sheet is stamped to form the first arc-shaped part 123a and the second arc-shaped part 123b, and the strip-shaped laminate is curled 360° to form the cylinder-like female signal terminal 12.

Certainly, in some other examples, the foregoing female signal terminal 12 may alternatively be formed in another forming manner.

A range of a central angle of each of the first arc-shaped part 123a and the second arc-shaped part 123b needs to be less than or equal to 90°. Arc lengths of the first arc-shaped part 123a and the second arc-shaped part 123b may be equal, or may be unequal.

In a possible implementation, refer to FIG. 10 and FIG. 11. The first arc-shaped part 123a and the second arc-shaped part 123b have an equal central angle and arc length, and the first arc-shaped part 123a and the second arc-shaped part 123b have a same structure. In this way, synchronization of signal transmission on the first arc-shaped part 123a and the second arc-shaped part 123b can be ensured. This helps further improve signal transmission performance of a connector and increase bandwidth of the connector. In addition, this facilitates forming, reduces a forming difficulty, and facilitates implementation.

With reference to FIG. 12, the female signal terminal 12 further includes a first extension part 124a and a second extension part 124b that are disposed opposite to each other. Specifically, there may be a gap 123 between the first arc-shaped part 123a and the second arc-shaped part 123b. It should be noted that the first arc-shaped part 123a and the second arc-shaped part 123b are disposed opposite to each other to form the cylinder-like female signal terminal 12. There is the gap 123 between the first arc-shaped part 123a and the second arc-shaped part 123b, that is, the first arc-shaped part 123a and the second arc-shaped part 123b are not in contact. There are two opposite gaps 123 between the first arc-shaped part 123a and the second arc-shaped part 123b.

The first extension part 124a is located at a second end of the first arc-shaped part 123a. The second extension part 124b is located at a second end of the second arc-shaped part 123b. Specifically, a first end of the first extension part 124a is connected to the second end of the first arc-shaped part 123a. A second end of the first extension part 124a extends towards the second extension part 124b. A first end of the second extension part 124b is connected to the second end of the second arc-shaped part 123b. A second end of the second extension part 124b extends towards the first extension part 124a. Refer to FIG. 11 and FIG. 12. The first extension part 124a and the second extension part 124b form a splayed structure, and the second end of the second extension part 124b is connected to the second end of the first extension part 124a.

In this way, the first arc-shaped part 123a and the second arc-shaped part 123b are connected through the first extension part 124a and the second extension part 124b. The male signal terminal 22 is in an electrical contact connection with the female signal terminal 12 at the port 122. Signals are transmitted separately through the first arc-shaped part 123a and the second arc-shaped part 123b, are converged when transmitted to the second end of the first arc-shaped part 123a and the second end of the second arc-shaped part 123b, and continue to be transmitted to a female cable connected to the female signal terminal 12. This ensures that the signals can be simultaneously transmitted from the male signal terminal 22 to the female cable during transmission. Compared with that the signals are transmitted to the female cable only through the first arc-shaped part 123a or the second arc-shaped part 123b, this can prevent an antenna effect occurring on the second end of the first arc-shaped part 123a and the second end of the second arc-shaped part 123b (for example, when the first arc-shaped part 123a is connected to the female cable, an antenna effect occurs on the second end of the second arc-shaped part 123b) from causing interference to the transmitted signals, and increases the bandwidth of the connector.

Specifically, still refer to FIG. 11 and FIG. 12. The female signal terminal 12 further includes a first connection part 125a and a second connection part 125b. The first connection part 125a is located at the second end of the first extension part 124a. The second connection part 125b is located at the second end of the second extension part 124b. The first connection part 125a is electrically connected to the female cable. The second connection part 125b is electrically connected to the first connection part 125a. In this way, the first extension part 124a is connected to the second extension part 124b, and the signals transmitted on the first arc-shaped part 123a and the second arc-shaped part 123b can be transmitted to the female cable, to prevent the antenna effect.

The first connection part 125a and the second connection part 125b may be disposed to facilitate a connection between the first extension part 124a and the second extension part 124b. The first connection part 125a and the second connection part 125b may be electrically connected by welding. For example, with reference to FIG. 13, a welded part 129 is formed by welding between the first connection part 125a and the second connection part 125b. The first connection part 125a and the second connection part 125b are connected through the welded part 129. Certainly, in some other examples, the first connection part 125a and the second connection part 125b may alternatively be electrically connected in another manner.

The first connection part 125a and the second connection part 125b may be in a shape of a flat plate. An extension direction of the first connection part 125a and the second connection part 125b may be consistent with an insertion direction of the male signal terminal 22. For example, the first connection part 125a and the second connection part 125b may extend in a horizontal direction. This can further facilitate the connection between the first connection part 125a and the second connection part 125b.

With reference to FIG. 10 and FIG. 14, the female signal terminal 12 may further include a ring-shaped part 126. The ring-shaped part 126 may be located between the first arc-shaped part 123a and the first extension part 124a, and between the second arc-shaped part 123b and the second extension part 124b. The second end of the first arc-shaped part 123a and the second end of the second arc-shaped part 123b each are connected to the ring-shaped part 126. The first end of the first extension part 124a and the second end of the second extension part 124b each are connected to the ring-shaped part 126. In addition, the accommodation cavity 121 communicates with an inner cavity of the ring-shaped part 126. The ring-shaped part 126 implements a connection between the first arc-shaped part 123a and the second arc-shaped part 123b and the connection between the first extension part 124a and the second extension part 124b. This can facilitate forming of the female signal terminal 12. For example, after the arc-shaped part, the extension part, and the ring-shaped part 126 are separately formed by stamping and curled 360°, the female signal terminal 12 is formed. A forming manner is simple, thereby facilitating mass production. In addition, the ring-shaped part 126 can be disposed to improve strength of the female signal terminal 12. This helps improve matching connection reliability.

After being stamped and curled, the first extension part 124a and the second extension part 124b may be closed, so that the first extension part 124a and the second extension part 124b extend to respectively form the first connection part 125a and the second connection part 125b that are in a shape of a flat plate. Then, the first connection part 125a and the second connection part 125b may be connected by welding, to obtain the foregoing female signal terminal 12.

Refer to FIG. 10 and FIG. 14. The female signal terminal 12 further includes a first guide part 127a and a second guide part 127b. The first guide part 127a is located at the first end of the first arc-shaped part 123a. The second guide part 127b is located at the first end of the second arc-shaped part 123b. Alternatively, the first guide part 127a and the second guide part 127b may be formed by stamping, and are disposed opposite to each other after being curled.

A first end of the first guide part 127a is connected to the first arc-shaped part 123a. A second end of the first guide part 127a extends away from the second guide part 127b. A first end of the second guide part 127b is connected to the second arc-shaped part 123b. A second end of the second guide part 127b extends away from the first guide part 127a. With reference to FIG. 14 and FIG. 15, the first guide part 127a and the second guide part 127b form a structure with a splayed cross section, that is, the structure with a splayed cross section is formed on a side that is of the port 122 and that faces the jack 13. The first guide part 127a and the second guide part 127b may guide the male signal terminal 22 to be inserted into the female signal terminal 12 through the port 122.

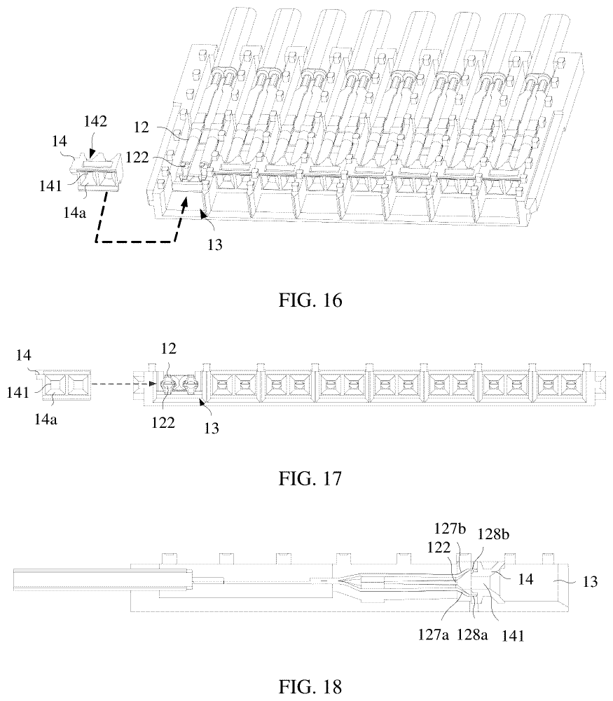

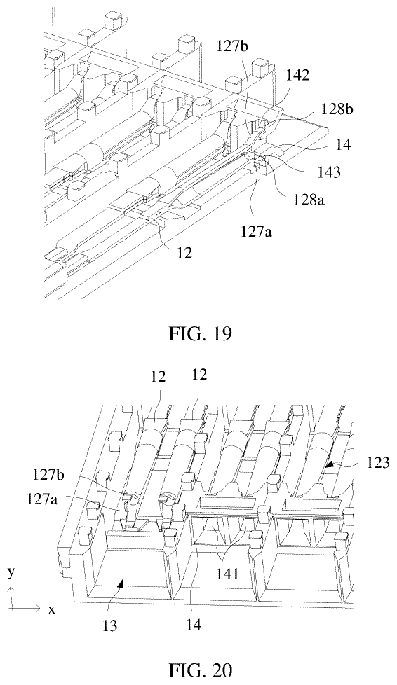

FIG. 16 is a schematic diagram of a partial disassembled structure of a plug connector in a female connector according to an embodiment of this application. FIG. 17 is a front view of a partial disassembled structure of a plug connector in a female connector according to an embodiment of this application. FIG. 18 is a front view of a cross section of a female connector according to an embodiment of this application. FIG. 19 is a partially enlarged schematic diagram of a cross-sectional structure of a female connector at a plug connector according to an embodiment of this application.

A plug connector 14 (as shown in FIG. 7 and FIG. 16) is further disposed in a housing assembly 11. The plug connector 14 is located between a jack 13 and a female signal terminal 12. Refer to FIG. 16 and FIG. 17. A through hole 141 is provided on the plug connector 14. The through hole 141 is disposed opposite to a port 122. In this way, after passing through the jack 13, a male signal terminal 22 first passes through the through hole 141 of the plug connector 14, and then passes through the port 122, to extend into an accommodation cavity 121 of the female signal terminal 12. The plug connector 14 can guide the male signal terminal 22 to be accurately and smoothly inserted into the accommodation cavity 121 of the female signal terminal 12. In addition, the plug connector 14 can further protect the female signal terminal 12, and avoid abrasion of the female signal terminal 12 caused by an insertion position deviation.

In addition, after passing through the through hole 141 on the plug connector 14, the male signal terminal 22 is plugged into the female signal terminal 12. The plug connector 14 can further clamp and fasten the male signal terminal 22, to ensure a true position and mechanical strength of the male signal terminal 22 when the male signal terminal 22 is inserted and extracted.

A guide surface 14a may be disposed at one end that is of the plug connector 14 and that faces the jack 13. The guide surface 14a may be in a shape of a trumpet. The guide surface 14a is disposed around the through hole 141, and a narrow end of the guide surface 14a is disposed close to the female signal terminal 12, to further guide the male signal terminal 22 to be accurately inserted into the female signal terminal 12. This reduces or avoids damage to the female signal terminal 12 or the male signal terminal 22 caused by a plug deviation.

When the female signal terminal 12 is disposed in the housing assembly 11, a second end of a first guide part 127a and a second end of a second guide part 127b each are disposed on the plug connector 14. Specifically, refer to FIG. 18. The female signal terminal 12 may further include a first pressing part 128a and a second pressing part 128b (as shown in FIG. 14 and FIG. 15) that are disposed opposite to each other. The first pressing part 128a is located at the second end of the first guide part 127a. The second pressing part 128b is located at the second end of the second guide part 127b. The first guide part 127a and the second guide part 127b are respectively disposed, through the first pressing part 128a and the second pressing part 128b, on two opposite sides of an outer periphery of the through hole 141.

To be specific, the first guide part 127a and the second guide part 127b are disposed on the outer periphery of the through hole 141. In this way, the through hole 141 communicates with the port 122 through a splayed structure formed by the first guide part 127a and the second guide part 127b. The first guide part 127a and the second guide part 127b can implement a guiding and limiting function, to further ensure that the male signal terminal 22 is accurately inserted into the female signal terminal 12. This reduces or avoids the damage to the male signal terminal 22 or the female signal terminal 12 caused by the plug deviation.

Refer to FIG. 19. A first positioning slot 142 and a second positioning slot 143 may be provided on a side that is of the plug connector 14 and that faces the female signal terminal 12. The first positioning slot 142 and the second positioning slot 143 are respectively located on sides of the outer periphery of the through hole 141. The first positioning slot 142 and the second positioning slot 143 are disposed opposite to each other. The first pressing part 128a may be disposed in the first positioning slot 142, pressing against the first positioning slot 142. Correspondingly, the second pressing part 128b is disposed in a second limiting slot 231, pressing against the second limiting slot 231.

In this way, the first guide part 127a is fastened to the plug connector 14 through cooperation between the first pressing part 128a and the first positioning slot 142, and the second guide part 127b is fastened to the plug connector 14 through cooperation between the second pressing part 128b and the second limiting slot 231, so that the female signal terminal 12 is fixedly connected to the plug connector 14. The first positioning slot 142 and the second positioning slot 143 can limit displacement of the female signal terminal 12, to stably dispose the female signal terminal in the housing assembly 11. This reduces or avoids displacement of the female signal terminal 12 in a process of assembly, use, or the like. In addition, the plug connector 14 can further prevent the female signal terminal 12 from sliding out of the jack 13. This further improves stability of the female signal terminal 12.

FIG. 20 is a schematic diagram of distribution of female signal terminals in a female connector according to an embodiment of this application.

In this embodiment of this application, one jack 13 corresponds to two female signal terminals 12. The two female signal terminals 12 form one signal differential pair. One plug connector 14 is correspondingly disposed in one jack 13. Two through holes 141 are provided on the plug connector 14. The two through holes 141 respectively correspond to jacks 122 of the two female signal terminals 12. In this case, the male signal terminal 22 is inserted into the female signal terminal 12 through the through hole 141 and the port 122.

Refer to FIG. 20. When the two female signal terminals 12 are disposed in a shielding cavity 112a, gaps 123 of the two female signal terminals 12 are disposed opposite to each other, a first arc-shaped part 123a and a second arc-shaped part 123b are located on upper and lower sides of the gap 123 (in a y direction in the figure), a first guide part 127a is located on the first arc-shaped part 123a, and a second guide part 127b is located on the second arc-shaped part 123b. In this case, the first guide part 127a and the second guide part 127b are located on the upper and lower sides of the gap 123, that is, two ends of a structure with a splayed cross section formed by the first guide part 127a and the second guide part 127b are located in a vertical direction (the y direction in the figure). This can reduce a size of the female signal terminal 12 in a horizontal direction (an x direction in the figure). In this way, when a width of a female connector 10 in the horizontal direction is fixed, more female signal terminals 12 can be placed. This helps implement a high-density design of the female connector 10, and further improves signal transmission performance of the female connector 10.

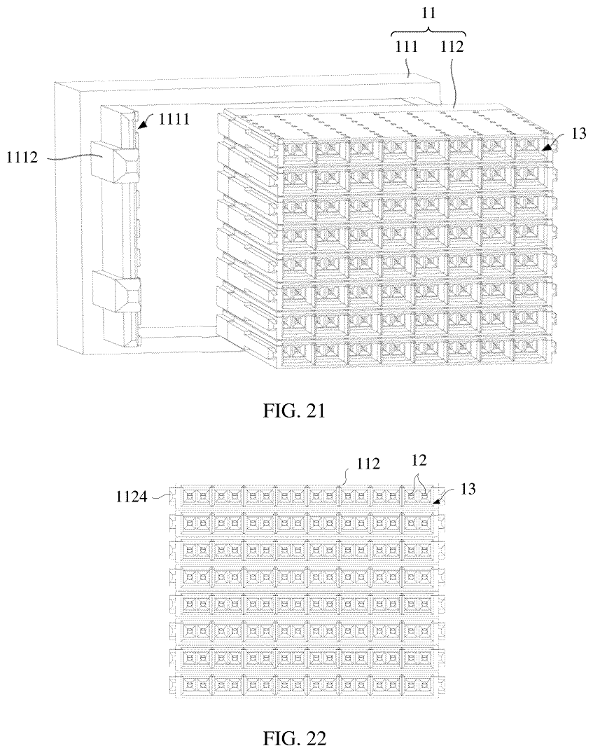

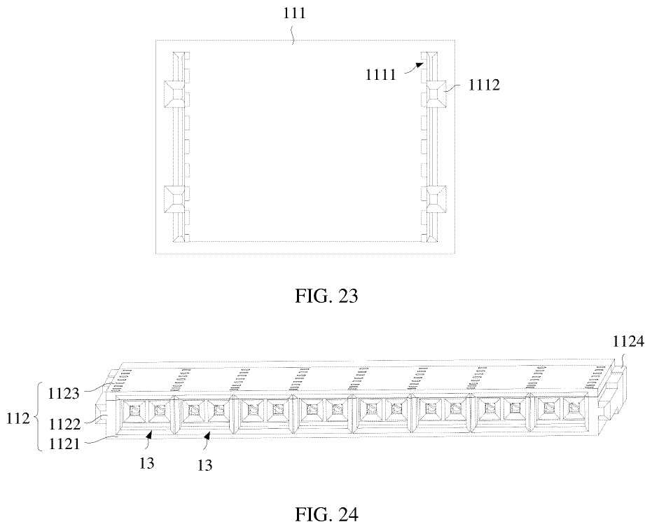

FIG. 21 is a schematic diagram of disassembly of a female connector according to an embodiment of this application. FIG. 22 is a schematic diagram of stacked shielding housings according to an embodiment of this application. FIG. 23 is a schematic diagram of a structure of a female housing according to an embodiment of this application.

In this embodiment of this application, refer to FIG. 21. A housing assembly 11 may include a shielding housing 112 and a female housing 111. There may be one shielding housing 112. Alternatively, refer to FIG. 21 and FIG. 22. There may be a plurality of shielding housings 112. The plurality of shielding housings 112 may be stacked. The female housing 111 is sleeved on one end of the shielding housing 112, to fasten the shielding housing 112. In addition, the female housing 111 may be fastened to a male housing 23 of a male connector 20.

For example, a plurality of shielding housings 112 are stacked. Each shielding housing 112 may have a plurality of jacks 13. A pair of female signal terminals 12 may be disposed in each shielding cavity 112a. The female housing 111 is sleeved on one end of a plurality of layers of shielding housings 112, to fasten the plurality of layers of shielding housings 112. This can implement a high-density design of the female signal terminal 12, and further improve signal transmission performance of a connector.

Specifically, there may be a limiting structure on the female housing 111 and each shielding housing 112, to implement a connection and fastening between the shielding housing 112 and the female housing 111. For example, refer to FIG. 22. There may be protruding first limiting parts 1124 on an outer wall of two ends of the shielding housing 112. Refer to FIG. 23. There may be a plurality of first limiting slots 1111 that cooperate with the first limiting parts 1124 on inner walls of the female housing 111. With reference to FIG. 21, the first limiting part 1124 may be inserted into the first limiting slot 1111. In this way, the shielding housing 112 can be connected to the female housing 111 through cooperation between the first limiting part 1124 and the first limiting slot 1111, and the plurality of layers of shielding housings 112 are sleeved and stacked in the female housing 111.

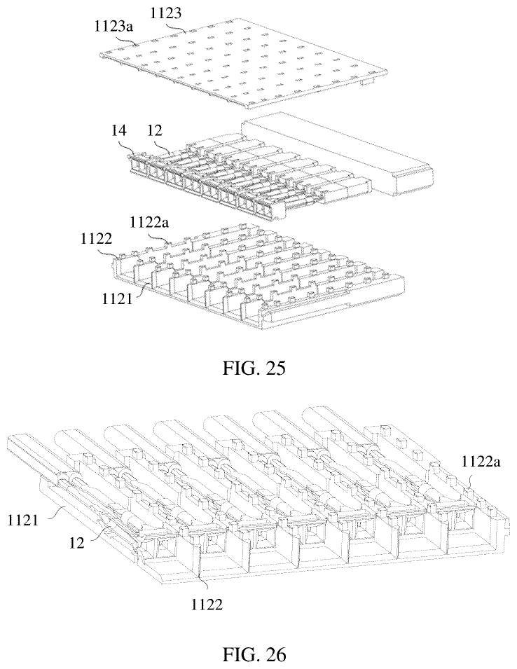

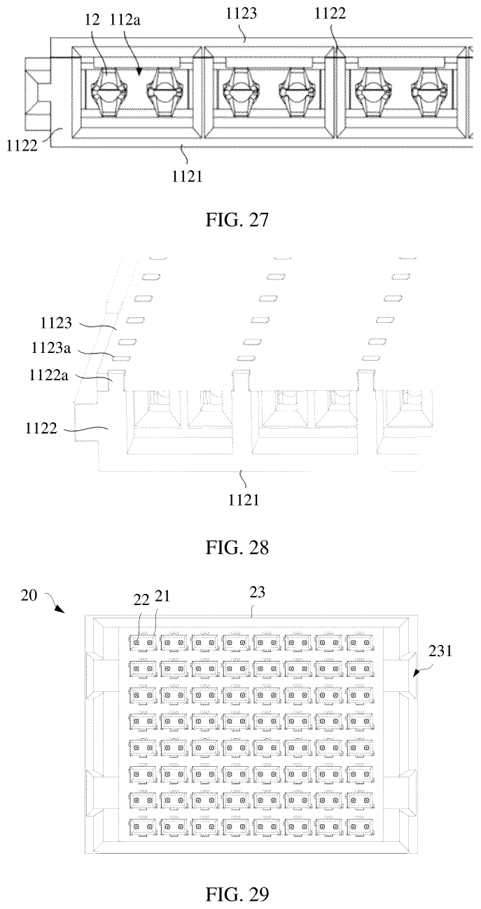

FIG. 24 is a schematic diagram of an assembly structure of a shielding housing and a female signal terminal according to an embodiment of this application. FIG. 25 is a schematic diagram of a disassembly structure of a shielding housing and a female signal terminal according to an embodiment of this application. FIG. 26 is a schematic diagram of an assembly structure of a bottom shielding sheet and a side shielding sheet according to an embodiment of this application. FIG. 27 is an enlarged view of a partial structure of assembly between a shielding housing and a female signal terminal according to an embodiment of this application. FIG. 28 is an enlarged view of a partial structure of assembly of a shielding housing according to an embodiment of this application.

Specifically, refer to FIG. 24 and FIG. 25. A shielding housing 112 includes a bottom shielding sheet 1121, a top shielding sheet 1123, and a plurality of side shielding sheets 1122. The plurality of side shielding sheets 1122 are disposed on the bottom shielding sheet 1121, and the plurality of side shielding sheets 1122 are disposed in parallel. Two side shielding sheets 1122 may be located on two opposite sides of the bottom shielding sheet 1121, and the top shielding sheet 1123 covers the side shielding sheets 1122. In this way, the bottom shielding sheet 1121, the side shielding sheets 1122, and the top shielding sheet 1123 together form a plurality of parallel shielding cavities 112a (as shown in FIG. 27). The shielding cavity 112a has openings at two ends. A first limiting part 1124 may be disposed on the side shielding sheet 1122.

A female signal terminal 12 is disposed in the shielding cavity 112a. Specifically, refer to FIG. 26. The female signal terminal 12 is disposed on the bottom shielding sheet 1121. With reference to FIG. 27, a pair of female signal terminals 12 is disposed in each shielding cavity 112a. The opening at one end of the shielding cavity 112a forms a jack 13. Two adjacent shielding cavities 112a are isolated. To be specific, the side shielding sheet 1122 isolates the two adjacent shielding cavities 112a, so that the two shielding cavities 112a do not communicate with each other and are isolated. In this way, each pair of female signal terminals 12 is located in a shielding cavity 112a that is fully enclosed around 360°, that is, a differential pair formed by the female signal terminals 12 is fully coated and enclosed. This ensures that there is no pore and connection between two adjacent shielding cavities 112a, reduces or avoids electromagnetic noise leakage, significantly enhances shielding effect, reduces or avoids crosstalk between adjacent signal differential pairs, and further increases bandwidth of a connector.

The top shielding sheet 1123 may also be connected to the side shielding sheet 1122 in a plurality of manners. For example, the top shielding sheet 1123 may be fixedly connected to one end of the side shielding sheet 1122 in a manner of clamping, bonding, threaded connection, an interference fit, or the like.

For example, in an implementation, a limiting boss 1122a (as shown in FIG. 26) may be disposed on the side shielding sheet 1122. A limiting clamping slot 1123a (as shown in FIG. 25) that cooperates with the limiting boss 1122a is provided on the top shielding sheet 1123. For example, refer to FIG. 28. The limiting boss 1122a can extend into the limiting clamping slot 1123a, and forms an interference fit with the limiting clamping slot 1123a. In this way, the top shielding sheet 1123 is connected to the side shielding sheet 1122 through the interference fit. A structure design is simple, and facilitates implementation and assembly.

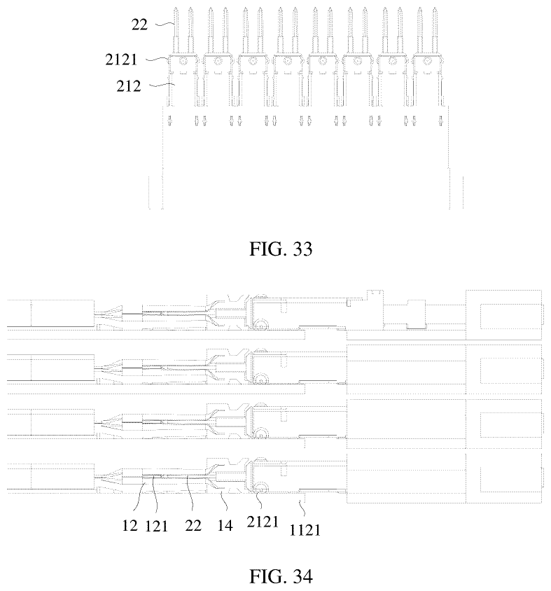

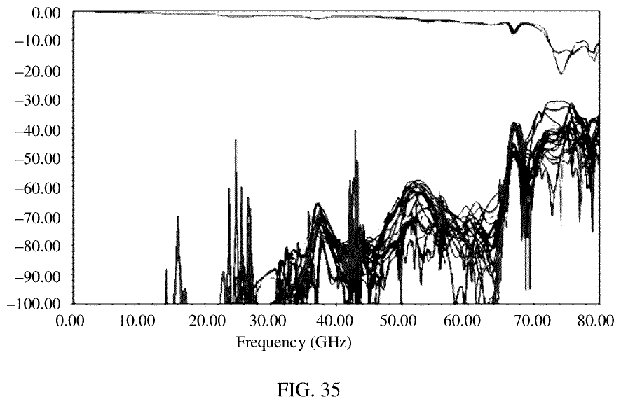

FIG. 29 is a schematic diagram of a structure of a male connector according to an embodiment of this application. FIG. 30 is a schematic diagram of a structure of a male housing according to an embodiment of this application. FIG. 31 is a schematic diagram of a cross-sectional structure of one layer of a male connector according to an embodiment of this application. FIG. 32 is a schematic diagram of a front structure of one layer of a male connector according to an embodiment of this application. FIG. 33 is a schematic diagram of a back structure of one layer of a male connector according to an embodiment of this application. FIG. 34 is a schematic diagram of a cross-sectional structure of matching between a male connector and a female connector according to an embodiment of this application.

An embodiment of this application provides a male connector 20, configured to be connected to the foregoing female connector 10. Refer to FIG. 29. The male connector 20 includes a support assembly 21 and a male signal terminal 22. The male signal terminal 22 is disposed on the support assembly 21. Specifically, the male connector 20 may further include a male housing 23. A plurality of support assemblies 21 arranged in an array and the male signal terminal 22 may be disposed in the male housing 23.

Refer to FIG. 30. For example, a plurality of assembly holes 232 may be provided in the male housing 23. The support assembly 21 may be inserted into the assembly hole 232 to be fastened in the male housing 23.

Refer to FIG. 31. The support assembly 21 includes a shielding member 212 and a terminal support member 211. The terminal support member 211 is configured to support the male signal terminal 22. One end of the male signal terminal 22 is located in the terminal support member 211. The other end of the male signal terminal 22 extends out of the terminal support member 211, that is, extends out of the support assembly 21. Two male signal terminals 22 may be disposed on each terminal support member 211, to form one signal differential pair.

The male signal terminal 22 may be integrally molded with the terminal support member 211 by injection molding. One end of the male signal terminal 22 is embedded into the terminal support member 211 by injection molding. This helps improve disposing stability and strength of the male signal terminal 22, and helps improve connection reliability between the male signal terminal 22 and a female signal terminal 12.

The male signal terminal 22 may be in a shape of a strip, a cylinder, or another pattern. In this embodiment of this application, an example in which the male signal terminal 22 is a straight strip-shaped terminal is used. An end part that is of the male signal terminal 22 and that extends out of one end of the terminal support member 211 may be of a tip structure, so that the male signal terminal 22 can be inserted into an accommodation cavity of the female signal terminal 12. The tip structure of the end part of the male signal terminal 22 may be formed by stamping for a plurality of times.

The shielding member 212 is disposed around an outer periphery of the terminal support member 211. Refer to FIG. 32 and FIG. 33. The shielding member 212 is coated on a side surface of the outer periphery of the terminal support member 211. In this way, the male signal terminal 22 can be fully coated and shielded. This improves shielding effect, and further increases bandwidth of the connector. When the male connector 20 is plugged into the female connector 10, one end of the support assembly 21 may be inserted into a jack 13 of the female connector 10 (as shown in FIG. 9), the male signal terminal 22 extending out of one end of the support assembly 21 may be inserted into the accommodation cavity 121 of the female signal terminal 12 through a port 122, and the male signal terminal 22 and the female signal terminal 12 are in an electrical contact connection at a position of the port 122. In this way, the male connector 20 is electrically connected to the female connector 10.

The shielding member 212 may include a plurality of shielding sheets. The plurality of shielding sheets each are disposed on the side surface of the outer periphery of the terminal support member 211. Two adjacent shielding sheets are connected to form the shielding member 212 surrounding the outer periphery of the terminal support member 211. For example, the terminal support member 211 is square. Shielding sheets are separately disposed on four side surfaces of the terminal support member 211, and then two adjacent shielding sheets may be connected by welding. Alternatively, the shielding member 212 may be a ring-shaped shielding sleeve, and is sleeved on the outer periphery of the terminal support member 211 as a whole.

Still refer to FIG. 32 and FIG. 33. There may be a protruding part 2121 on an outer wall of the shielding member 212. Refer to FIG. 34. When the support assembly 21 is inserted into the jack 13, the protruding part 2121 on the shielding member 212 presses against and forms an interference fit with an inner wall of the jack 13 (namely, an inner wall of a bottom shielding sheet 1121). In this way, the support assembly 21 is fastened in the jack 13, and the male connector 20 is fastened in the jack 13. This further improves connection stability between the male connector 20 and the female connector 10.

FIG. 35 is a schematic diagram of a simulation result of an insertion loss and crosstalk of a connector assembly according to an embodiment of this application.

A connector assembly 100 provided by this embodiment of this application includes the foregoing female connector 10 and male connector 20. Refer to FIG. 35. There is no resonance of the insertion loss of the connector assembly 100 when a frequency is less than 70 GHz, and crosstalk can be ensured to be less than −40 dB when the frequency is less than 70 GHz. This significantly increases bandwidth of the connector assembly 100 to be greater than 60 dB, and improves signal transmission reliability.

Finally, it should be noted that the foregoing embodiments are only intended for describing the technical solutions of embodiments of this application other than limiting embodiments of this application. Although embodiments of this application are described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of embodiments of this application.

What is claimed is:

1. A female connector, configured to be connected to a male connector, and comprising a housing assembly and a female signal terminal located in the housing assembly, wherein one end of the housing assembly is provided with a jack that is used to plug into the male connector; and
the female signal terminal has an accommodation cavity, one end that is of the female signal terminal and that faces the jack has a port, the port communicates with the accommodation cavity, the female signal terminal is configured to enable a male signal terminal of the male connector to be inserted into the accommodation cavity through the port, and the female signal terminal is in an electrical contact connection with the male signal terminal at the port.

2. The female connector according to claim 1, wherein the female signal terminal comprises a first arc-shaped part and a second arc-shaped part, the first arc-shaped part and the second arc-shaped part are disposed opposite to each other to form the accommodation cavity, and a first end of the first arc-shaped part and a first end of the second arc-shaped part form the port.

3. The female connector according to claim 2, wherein there is a gap between the first arc-shaped part and the second arc-shaped part;
the female signal terminal further comprises a first extension part and a second extension part that are disposed opposite to each other, wherein a first end of the first extension part is connected to a second end of the first arc-shaped part, and a second end of the first extension part extends towards the second extension part; and
a first end of the second extension part is connected to a second end of the second arc-shaped part, a second end of the second extension part extends towards the first extension part, and the second end of the second extension part is connected to the second end of the first extension part.

4. The female connector according to claim 3, further comprising a female cable, wherein one end of the female cable is located in the housing assembly, and the other end of the female cable extends out of the housing assembly;
the female signal terminal further comprises a first connection part and a second connection part, the first connection part is located on the second end of the first extension part, and the first connection part is electrically connected to one end of the female cable; and
the second connection part is located on the second end of the second extension part, and the second connection part is electrically connected to the first connection part.

5. The female connector according to claim 3, further comprising a plug connector, wherein the plug connector is located between the jack and the female signal terminal, the plug connector is provided with a through hole, and the through hole is provided opposite to the port.

6. The female connector according to claim 5, wherein the female signal terminal further comprises a first guide part and a second guide part, the first guide part is located on the first end of the first arc-shaped part, and the second guide part is located on the first end of the second arc-shaped part;
a first end of the first guide part is connected to the first arc-shaped part, a second end of the first guide part extends away from the second guide part, and the second end of the first guide part is located on the plug connector; and
a first end of the second guide part is connected to the second arc-shaped part, a second end of the second guide part extends away from the first guide part, the second end of the second guide part is located on the plug connector, and the second end of the first guide part and the second end of the second guide part are respectively located on two opposite sides of an outer periphery of the through hole.

7. The female connector according to claim 6, wherein each jack corresponds to a pair of female signal terminals, and gaps of the pair of female signal terminals are opposite to each other.

8. The female connector according to claim 6, wherein there are a first positioning slot and a second positioning slot on a side that is of the plug connector and that faces the female signal terminal, and the first positioning slot and the second positioning slot are respectively located on two opposite sides of the outer periphery of the through hole;
the female signal terminal further comprises a first pressing part and a second pressing part, the first pressing part is located on the second end of the first guide part, and the second pressing part is located on the second end of the second guide part; and
the first guide part is disposed on the plug connector through cooperation between the first pressing part and the first positioning slot, and the second guide part is disposed on the plug connector through cooperation between the second pressing part and the second positioning slot.

9. The female connector according to claim 3, wherein the female signal terminal further comprises a ring-shaped part, the second end of the first arc-shaped part and the second end of the second arc-shaped part are separately connected to the ring-shaped part, the first end of the first extension part and the first end of the second extension part are separately connected to the ring-shaped part, and the accommodation cavity communicates with an inner cavity of the ring-shaped part.

10. The female connector according to claim 1, wherein the housing assembly comprises a shielding housing, the shielding housing comprises a bottom shielding sheet, a top shielding sheet, and a plurality of side shielding sheets, the plurality of side shielding sheets are disposed in parallel on the bottom shielding sheet, and the top shielding sheet covers the plurality of side shielding sheets; and
the bottom shielding sheet, the side shielding sheets, and the bottom shielding sheet form a plurality of shielding cavities with openings at two ends, an opening at one end of the shielding cavity forms the jack, a pair of female signal terminals is disposed in each shielding cavity, and two adjacent shielding cavities are isolated through the side shielding sheet.

11. The female connector according to claim 10, wherein there are a plurality of shielding housings, and the plurality of shielding housings are stacked.

12. The female connector according to claim 11, wherein the housing assembly further comprises a female housing, and the female housing is sleeved on one end of each of the plurality of shielding housings.

13. The female connector according to claim 12, wherein there is a protruding first limiting part on an outer wall of two ends of the shielding housing, an inner wall of the female housing is provided with a first limiting slot cooperating with the first limiting part, and the shielding housing is connected to the female housing through cooperation between the first limiting part and the first limiting slot.

14. The female connector according to claim 10, wherein there is a limiting boss on the side shielding sheet, the top shielding sheet is provided with a limiting clamping slot cooperating with the limiting boss, and the top shielding sheet is connected to the side shielding sheet through cooperation between the limiting boss and the limiting clamping slot.

15. A male connector, configured to be connected to a female connector, and comprising a support assembly and a male signal terminal, wherein
the female connector comprises a housing assembly and a female signal terminal located in the housing assembly, wherein one end of the housing assembly is provided with a jack that is used to plug into the male connector; and
the female signal terminal has an accommodation cavity, one end that is of the female signal terminal and that faces the jack has a port, the port communicates with the accommodation cavity, the female signal terminal is configured to enable a male signal terminal of the male connector to be inserted into the accommodation cavity through the port, and the female signal terminal is in an electrical contact connection with the male signal terminal at the port; wherein
the support assembly comprises a terminal support member and a shielding member, the shielding member is disposed around an outer periphery of the terminal support member, one end of the male signal terminal is located in the terminal support member, and the other end of the male signal terminal extends out of one end of the support assembly; and
the end of the support assembly is configured to be inserted into the jack, so that the male signal terminal is inserted into an accommodation cavity of the female signal terminal.

16. The male connector according to claim 15, wherein there is a protruding part on the shielding member, and the protruding part is configured to cooperate with an inner wall of the jack, so that the support assembly is disposed in the jack.

17. The male connector according to claim 15, further comprising a male housing, wherein a plurality of support assemblies are arranged in an array in the male housing.

18. A connector assembly, comprising a female connector, comprising a housing assembly and a female signal terminal located in the housing assembly, wherein one end of the housing assembly is provided with a jack that is used to plug into the male connector; and
the female signal terminal has an accommodation cavity, one end that is of the female signal terminal and that faces the jack has a port, the port communicates with the accommodation cavity, the female signal terminal is configured to enable a male signal terminal of the male connector to be inserted into the accommodation cavity through the port, and the female signal terminal is in an electrical contact connection with the male signal terminal at the port and
a male connector, comprising a support assembly and a male signal terminal, wherein
the female connector comprises a housing assembly and a female signal terminal located in the housing assembly, wherein one end of the housing assembly is provided with a jack that is used to plug into the male connector; and
the female signal terminal has an accommodation cavity, one end that is of the female signal terminal and that faces the jack has a port, the port communicates with the accommodation cavity, the female signal terminal is configured to enable a male signal terminal of the male connector to be inserted into the accommodation cavity through the port, and the female signal terminal is in an electrical contact connection with the male signal terminal at the port; wherein
the support assembly comprises a terminal support member and a shielding member, the shielding member is disposed around an outer periphery of the terminal support member, one end of the male signal terminal is located in the terminal support member, and the other end of the male signal terminal extends out of one end of the support assembly; and
the end of the support assembly is configured to be inserted into the jack, so that the male signal terminal is inserted into an accommodation cavity of the female signal terminal, wherein
the male connector is plugged into the female connector through the jack, the male signal terminal is inserted into an accommodation cavity of the female connector through the port, and the male signal terminal is in an electrical contact connection with the female signal terminal.

19. The connector assembly according to claim 18, wherein one end of a female housing of the female connector is plugged into a male housing of the male connector; and
there is a protruding second limiting part on an outer wall of one end of the female housing, an inner wall of the male housing is provided with a second limiting slot cooperating with the second limiting part, and the female housing is connected to the male housing through cooperation between the second limiting part and the second limiting slot.
